(19) United States
(12) Patent Application Publication
(10) Pub. No.: US 2023/0312361 A1
(43) Pub. Date: Oct. 5, 2023

(54) Method Of Producing Antimony Trisulfide

(71) Applicant: NIHON SEIKO Co., Ltd., Tokyo (JP)

(72) Inventors: Satoshi KITAZONO, Yabu-shi (JP); Shinya YOSHITANI, Yabu-shi (JP); Atsushi FUKUMOTO, Yabu-shi (JP)

(21) Appl. No.: 18/183,540

(22) Filed: Mar. 14, 2023

(30) Foreign Application Priority Data
Mar. 31, 2022 (JP) 2022-058823

(51) Int. Cl. C01G 30/00

(52) U.S. Cl. CPC C01G 30/008; C01P 2004/61

(57) ABSTRACT

A method of producing antimony trisulfide is provided, including: mixing metal antimony powder, antimony trioxide powder, and sulfur powder to provide a mixture; and heating the mixture.

### CROSS-REFERENCE TO RELATED APPLICATION

The entire disclosure of Japanese Patent Application No. 2022-058823, filed on Mar. 31, 2022, is hereby incorporated by reference.

### BACKGROUND OF THE INVENTION

The present invention relates to a method of producing antimony trisulfide.

There is a demand for antimony trisulfide in fields of, for example, gunpowder and a solid lubricant. Such antimony trisulfide may exhibit satisfactory characteristics in accordance with the respective fields, and hence stable and inexpensive supply of antimony trisulfide from the market is required.

In, for example, WO 2014/054112 A1, there is a disclosure of a method of producing antimony trisulfide, the method being characterized by including loading antimony trioxide powder and sulfur into a reaction vessel, and heating the inside of the vessel to from 250° C. to 700° C. to cause antimony trioxide and sulfur to react with each other. In addition, a method of producing antimony trisulfide, the method including mixing metal antimony powder and sulfur, and heating the mixture to cause the materials to react with each other, has been widely known.

In the method of producing antimony trisulfide disclosed in the above-mentioned WO 2014/054112 A1, a large amount of heat is required, and a large amount of sulfur dioxide is generated by a reaction between oxygen in antimony trioxide and sulfur. In addition, in the method of producing antimony trisulfide including mixing the metal antimony powder and sulfur, and heating the mixture to cause the materials to react with each other, there has been a case in which unreacted sulfur is abruptly vaporized by reaction heat in the reaction to cause an explosion and a decrease in reaction ratio due to the explosion.

### SUMMARY

According to at least one embodiment of the present invention, there can be provided a method of producing antimony trisulfide, which is safe, suppresses energy required for the production, and the generation of sulfur dioxide, and allows stable production of antimony trisulfide having satisfactory purity.

### DETAILED DESCRIPTION OF THE EMBODIMENT

The present invention has been made in order to solve at least part of the above-mentioned problems, and can be realized as the following aspects or application examples.

A method of producing antimony trisulfide according to one aspect of the present invention includes: mixing metal antimony powder, antimony trioxide powder, and sulfur powder to provide a mixture; and heating the mixture.

According to such production method, as a result of including the metal antimony powder as a raw material, antimony trisulfide having satisfactory purity can be stably produced.

In the above-mentioned aspect, a ratio (M_{O}:M_{M}) between an Sb mass (M_{O}) in the antimony trioxide powder and an Sb mass (M_{M}) in the metal antimony powder in the mixture may fall within the range of from 1:2 to 2:1.

In the above-mentioned aspect, a maximum attainable temperature in the heating may be 300° C. or more and 800° C. or less.

In the above-mentioned aspect, the metal antimony powder may have an average particle diameter of 120 μm or less.

In the above-mentioned aspect, the antimony trioxide powder may have an average particle diameter of 8 μm or less.

In the above-mentioned aspect, the mixture may have a total mass of 1 kg or more.

Some embodiments of the present invention are described below. The embodiments described below are each a mere example describing the present invention. The present invention is by no means limited to the following embodiments, and includes various modification examples performed within the scope that does not change the gist of the present invention. Not all of the configurations described below should necessarily be taken as essential configurations of the present invention.

### 1. Method of Producing Antimony Trisulfide

A method of producing antimony trisulfide according to one embodiment of the present invention includes: a mixing step of mixing metal antimony powder, antimony trioxide powder, and sulfur powder to provide a mixture; and a heating step of heating the mixture.

### 1.1. Mixing Step

The mixing step includes mixing the metal antimony powder, the antimony trioxide powder, and the sulfur powder to provide the mixture. The mixing is performed by introducing the metal antimony powder, the antimony trioxide powder, and the sulfur powder into an appropriate vessel to be described later. The order of the introduction is not particularly limited.

1.1.1. Metal Antimony Powder

Metal antimony may be produced by, for example, a method described in Japanese Patent Application Laid-open No. Hei 6-322455. The metal antimony powder can be obtained through the pulverization of metal antimony by a known method.

The particle diameters and particle diameter distribution of the particles of the metal antimony powder can be adjusted by using a known method. The particle diameters and particle diameter distribution of the particles of the metal antimony powder are not particularly limited. However, the metal antimony powder preferably has an average particle diameter of 120 μm or less. In addition, when the average particle diameter of the metal antimony powder is smaller, its reactivity with the antimony trioxide powder and the sulfur powder tends to improve, and hence the average particle diameter is more preferably 80 μm or less, still more preferably 60 μm or less.

Herein, the average particle diameter of the powder is measured by a laser diffraction/scattering method, and is defined as a 50% integrated particle diameter (D50) determined by volume frequency particle size distribution measurement. An example of a commercially available laser diffraction particle size distribution-measuring device that enables such measurement is MT3300EX II manufactured by MicrotracBEL Corp.

1.1.2. Antimony Trioxide Powder

Antimony trioxide may be produced by, for example, a method described in Japanese Patent Application Laid-open No. Hei 6-329417. The antimony trioxide powder can be obtained through the pulverization of antimony trioxide by a known method.

The particle diameters and particle diameter distribution of the particles of the antimony trioxide powder can also be adjusted by using a known method. The particle diameters and particle diameter distribution of the particles of the antimony trioxide powder are not particularly limited. However, the antimony trioxide powder preferably has an average particle diameter of 8 μm or less. When the average particle diameter is more than 8 μm, the reactivity of the powder with any other powder and energy cost tend to deteriorate, with the result that unreacted antimony trioxide tends to remain in the produced antimony trisulfide. From the viewpoint of avoiding such tendency, the average particle diameter of the antimony trioxide powder is preferably smaller, more preferably 1.5 μm or less, still more preferably 1 μm or less.

The antimony trioxide powder may be obtained by, for example, volatilization oxidation smelting, and hence has a small particle diameter and a large specific surface area, and has satisfactory reactivity. Further, high-purity antimony trioxide powder containing small amounts of impurities, such as lead, arsenic, and crystalline silica, is easily available. When the high-purity antimony trioxide powder is used as a raw material, antimony trisulfide containing smaller amounts of impurities can be produced.

1.1.3. Sulfur Powder

Sulfur is available from, for example, the market as powder or a lump. The sulfur powder can be obtained through the pulverization of sulfur by a known method as required.

The particle diameters and particle diameter distribution of the particles of the sulfur powder can also be adjusted by using a known method. The particle diameters and particle diameter distribution of the particles of the sulfur powder are not particularly limited. However, the sulfur powder preferably has an average particle diameter of preferably 500 μm or less. The average particle diameter of the sulfur powder is preferably smaller, more preferably 250 μm or less, still more preferably 100 μm or less.

In addition, the shape of each sulfur particle of the sulfur powder is not particularly limited, and the shape may be, for example, a spherical, scale-like, needle-like, or indefinite shape, or a mixed shape of those shapes. In addition, the particle diameters and shapes of the sulfur particles in the powder need not be uniform.

The sulfur powder to be used in the mixing step is powder or a lump. When the sulfur powder is handled at a temperature of 119° C. or less, preferably 112° C. or less, more preferably 106° C. or less, the properties of the powder can be maintained. In the mixing step, part or the entirety of the sulfur powder may be melted.

1.1.4. Vessel

The vessel to be used in the mixing step is not particularly limited, and, for example, a vessel appropriately including a raw material introduction port, a product discharge port, a gas inflow port, and a gas outflow port may be used. In addition, the vessel may or may not be sealed. The vessel may further include, for example, a heating mechanism, a stirring mechanism, or a safety mechanism.

A scale of the vessel is also not limited, and a vessel having an appropriate volume is used as the vessel in accordance with the amount of antimony trisulfide to be produced. In the method of producing antimony trisulfide of this embodiment, the total mass of the mixture obtained in the mixing step is more preferably set to 1 kg or more. When the vessel has such scale, the productivity of antimony trisulfide can be further enhanced.

The vessel may be a batch system or a continuous system. The mixture may be introduced into the vessel in accordance with the system of the vessel.

1.1.5. Mixing Ratio

A mixing ratio of the metal antimony powder, the antimony trioxide powder, and the sulfur powder is not particularly limited as long as the mixing ratio falls within the vicinity of the stoichiometric ratio.

However, a ratio (M_{O}:M_{M}) between an Sb mass (M_{O}) in the antimony trioxide powder and an Sb mass (M_{M}) in the metal antimony powder in the mixture more preferably falls within the range of from 1:2 to 2:1.

In addition, the sulfur powder is more preferably mixed in an amount in excess of its stoichiometric amount in antimony trisulfide. Such mixing substantially eliminates a risk in that unreacted metal antimony or antimony trioxide remains in antimony trisulfide to be produced.

In addition, the purity of sulfur to be used in the mixing step is preferably as high as possible, but for example, an impurity, such as any other element or a sulfur compound, may be included as long as the amount of the impurity is a certain amount or less. Such impurity includes, for example, an impurity in a sulfur base material, or an impurity mixed therein during the handling of the powder or the lump. The amount of such impurity is preferably 2 mass % or less, more preferably 1 mass % or less, still more preferably 0.5 mass % or less, still more preferably 0.1 mass % or less, particularly preferably 0.01 mass % or less. The sulfur is preferably substantially free of impurities.

### 1.2. Heating Step

The heating step includes heating the mixture obtained in the above-mentioned mixing step. The heating may be performed by, for example, contact heating with a heater or the like, or radiant heating with an infrared lamp or the like.

When antimony trisulfide is produced by heating the inside of the vessel, purging may be performed by constantly flowing an inert gas into the vessel. Such purging can suppress a reaction between metal antimony and oxygen in the air.

When the metal antimony powder, the antimony trioxide powder, and the sulfur powder are heated in the vessel, metal antimony combines with sulfur to become antimony trisulfide. In addition, antimony trioxide is deprived of oxygen by sulfur to generate SO₂ as a gas, and further, antimony reduced by sulfur combines with sulfur to become antimony trisulfide. The respective reaction formulae are as described below.

2Sb₂O₃+9S→2Sb₂S₃+3SO₂ (I)

2Sb+3S→2Sb₂S₃ (II)

When only antimony trioxide is used as in the above-mentioned formula (I), a large amount of a sulfurous acid gas is generated, but when part thereof is replaced with metal antimony as in the above-mentioned formula (II), generation of the sulfurous acid gas can be reduced.

The maximum attainable temperature in the heating step may be 300° C. or more and 800° C. or less. Herein, the maximum attainable temperature refers to a temperature of the mixture, and is a temperature when the mixture achieves its highest temperature in the heating step. Accordingly, the maximum attainable temperature does not refer to a temperature of a heater for heating.

When the mixture undergoes the heating step, antimony trisulfide is produced. The produced antimony trisulfide may be melted by heating to its melting point or higher to be discharged from the vessel as a liquid. In this case, the discharged liquid antimony sulfide may be cooled and solidified. The melting point of antimony trisulfide is 550° C. With such configuration, antimony trisulfide can be efficiently produced. In addition, with such configuration, antimony trisulfide can be easily produced in a continuous system.

### 1.3. Actions and Effects

According to the method of producing antimony trisulfide of the embodiments, antimony trisulfide having satisfactory purity can be stably produced, and generation of sulfur dioxide can be suppressed.

### 2. Examples and Comparative Examples

Now, the present invention is more specifically described by way of Examples and Comparative Examples, but the present invention is not limited to these examples.

### 2.1. Experiment Contents

Metal antimony powder, antimony trioxide powder, and sulfur powder were prepared. METAL-P manufactured by Nihon Seiko Co., Ltd. was obtained as the metal antimony powder. PATOX-M, PATOX-C, and PATOX-L manufactured by Nihon Seiko Co., Ltd. were each obtained as the antimony trioxide powder. Fine powder sulfur 200 mesh manufactured by Hosoi Chemical Industry Co., Ltd. was obtained as the sulfur powder.

An average particle diameter of metal antimony was adjusted by a pulverization time of a vibration ball mill.

In conformity to formulations shown in Table 1 and Table 2, the mixture of each example was loaded into a crucible, and was heated to a temperature shown in Table 1 or Table 2. A temperature increase rate was set to about 6.7° C./min, provided that the temperature increase rate was set to about 3.0° C./min in Example 5, and to about 6.4° C./min in Examples 21 and 22.

The scales, the formulations, the average particle diameters (D50) of the metal antimony powder and the antimony trioxide powder, the temperatures at the time of the reaction, and the evaluation results in Examples and Comparative Examples are shown in Table 1 and Table 2.

TABLE 1

| | | | | | | | | Average | Average | | | | |
|---|---|---|---|---|---|---|---|---|---|---|---|---|---|
| | | | | | Sulfur addition ratio | | | particle | particle | | | | |
| | | | | | Molar | Molar | | diameter | diameter | | | | |
| | | | Mass ratio (%) of Sb | | ratio with | ratio with | Excessive | (D50) of | of | Temperature | Evaluation results | | |
| | | | content | | respect to | respect to | sulfur | metal | antimony | at the time of | | | SO₂ |
| | | Scale | Metal | Antimony | metal | antimony | amount | antimony | trioxide | reaction | | | generation |
| | | kg | antimony | trioxide | antimony | trioxide | g | μm | μm | ° C. | Quality | Safety | amount |
| Example | 1 | 5.0 | 50 | 50 | 1.1 | 1.2 | 283 | 17 | 1.0 | 400 | A | A | B |
| | 2 | 5.0 | 50 | 50 | 1.1 | 1.1 | 177 | 12 | 1.0 | 400 | B | A | A |
| | 3 | 5.0 | 67 | 33 | 1.1 | 1.2 | 236 | 12 | 1.0 | 400 | B | A | A |
| | 4 | 5.0 | 33 | 67 | 1.1 | 1.2 | 330 | 12 | 1.0 | 450 | B | A | B |
| | 5 | 5.0 | 33 | 67 | 1.1 | 1.2 | 330 | 12 | 1.0 | 700 | A | A | B |
| | 6 | 5.0 | 33 | 67 | 1.1 | 1.2 | 330 | 12 | 1.0 | 500 | B | A | B |
| | 7 | 5.0 | 33 | 67 | 1.1 | 1,2 | 330 | 42 | 1.0 | 700 | A | B | B |
| | 8 | 5.0 | 33 | 67 | 1.1 | 1.2 | 330 | 12 | 1.0 | 550 | A | A | B |
| | 9 | 5.0 | 33 | 67 | 1.1 | 1.2 | 330 | 14 | 1.0 | 750 | A | A | B |
| | 10 | 5.0 | 33 | 67 | 1.1 | 1.2 | 330 | 14 | 1.0 | 700 | A | B | B |
| | 11 | 5.0 | 33 | 67 | 1.1 | 1.2 | 330 | 14 | 1.0 | 550 | A | B | B |
| | 12 | 5.0 | 33 | 67 | 1.1 | 1.2 | 330 | 14 | 1.0 | 600 | A | B | B |
| | 13 | 5.0 | 33 | 67 | 1.2 | 1.2 | 378 | 14 | 1.0 | 550 | A | B | B |
| | 14 | 5.0 | 33 | 67 | 1.2 | 1.2 | 378 | 10 | 1.0 | 550 | A | B | B |
| | 15 | 5.0 | 33 | 67 | 1.1 | 1.2 | 330 | 10 | 1.0 | 550 | A | B | B |

TABLE 2

| | | | | | | | | Average | Average | | | | |
|---|---|---|---|---|---|---|---|---|---|---|---|---|---|
| | | | | | Sulfur addition ratio | | | particle | particle | Temper- | | | |
| | | | | | Molar ratio | Molar ratio | | diameter | diameter | ature | | | |
| | | | Mass ratio (%) of Sb | | with | with | Excessive | (D50) of | of | at the | Evaluation results | | |
| | | | content | | respect to | respect to | sulfur | metal | antimony | time of | | | SO₂ |
| | | Scale | Metal | Antimony | metal | antimony | amount | antimony | trioxide | reaction | | | generation |
| | | kg | antimony | trioxide | antimony | trioxide | g | μm | μm | ° C. | Quality | Safety | amount |
| Example | 16 | 5.0 | 33 | 67 | 1.2 | 1.2 | 378 | 10 | 7.7 | 600 | A | B | B |
| | 17 | 5.0 | 33 | 67 | 1.1 | 1.2 | 330 | 33 | 1.0 | 550 | A | B | B |
| | 18 | 5.0 | 33 | 67 | 1.1 | 1.2 | 330 | 21 | 1.0 | 550 | A | B | B |
| | 19 | 5.0 | 33 | 67 | 1.2 | 1.2 | 378 | 120 | 1.0 | 600 | A | B | B |
| | 20 | 5.0 | 33 | 67 | 1.2 | 1.2 | 378 | 10 | 1.0 | 900 | A | B | B |
| | 21 | 105.0 | 33 | 67 | 1.05 | 1.05 | 1,980 | 34 | 0.5 | 700 | A | A | B |
| | 22 | 135.0 | 33 | 67 | 1.1 | 1.1 | 5,100 | 34 | 0.5 | 700 | A | A | B |
| Compar- | 1 | 1.5 | 100 | 0 | 1.1 | 0 | 41 | 14 | 1.0 | 700 | C | C | A |
| ative | 2 | 1.5 | 100 | 0 | 1 | 0 | 0 | 14 | 1.0 | 700 | A | C | A |
| Example | 3 | 1.5 | 100 | 0 | 1.1 | 0 | 41 | 14 | 1.0 | 700 | A | C | A |
| | 4 | 1.5 | 0 | 100 | 1 | 1.2 | 93 | — | 1.0 | 400 | B | A | C |
| | 5 | 5.0 | 0 | 100 | 1 | 1.2 | 382 | — | 1.0 | 600 | A | A | C |
| | 6 | 1.5 | 100 | 0 | 1 | 0 | 0 | 42 | 1.0 | 700 | C | C | A |
| | 7 | 1.5 | 100 | 0 | 1 | 0 | 42 | 12 | 1.0 | 400 | C | C | A |

The items shown in Table 1 and Table 2 are described below.
Scale (kg): Raw materials were blended so as to have the mass shown when synthesis was completed by 100%.
Mass ratio (%) of Sb content “metal antimony”: A mass ratio of Sb in metal antimony when the total mass of Sb in metal antimony and antimony trioxide in the mixture is set to 100 is shown.
Mass ratio (%) of Sb content “antimony trioxide”: A mass ratio of Sb in antimony trioxide when the total mass of Sb in metal antimony and antimony trioxide in the mixture is set to 100 is shown.
Sulfur addition ratio “molar ratio with respect to metal antimony”: A ratio of the number of moles of sulfur added as a raw material to the number of moles obtained by multiplying the number of moles of metal antimony serving as a raw material by 1.5 in accordance with the above-mentioned formula (II) is shown.
Sulfur addition ratio “molar ratio with respect to antimony trioxide”: A ratio of the number of moles of sulfur added as a raw material to the number of moles obtained by multiplying the number of moles of antimony trioxide by 4.5 in accordance with the above-mentioned formula (I) is shown.
Excessive sulfur amount (g): A mass of sulfur blended in an excess amount with respect to a mass of sulfur in its stoichiometric amount for obtaining antimony trisulfide (see the above-mentioned formulae (I) and (II)) is shown.
Average particle diameter (D50) (μm) of metal antimony: A result obtained by measurement using a laser diffraction particle size distribution-measuring device “MT3300EX II” manufactured by MicrotracBEL Corp. is shown.
Average particle diameter (μm) of antimony trioxide: An average particle diameter (BET equivalent particle diameter) calculated from a specific surface area determined with a specific surface area-measuring device Macsorb 1210 manufactured by Mountech Co., Ltd. is shown, provided that measurement is performed using the above-mentioned laser diffraction particle size distribution-measuring device in Example 16.
Temperature (° C.) at the time of reaction: The maximum attainable temperature of a substance inside the crucible is shown.

### 2.2. Evaluation Contents

(1) Evaluation of Quality

A content of antimony trisulfide in the product obtained in each example was determined by XRD Rietveld analysis by using X'Pert PRO MPD manufactured by PANalytical B.V. A higher content of antimony trisulfide indicates higher purity. The evaluation was performed by the following evaluation criteria (3 stages), and the results are shown in Table 1 and Table 2.

Evaluation criteria: the content of antimony trisulfide is
A: 95% or more,
B: 90% or more and less than 95%, or
C: less than 90%.

(2) Evaluation of Safety

In each example, the crucible during the reaction was observed with a monitor. The evaluation was performed by the following evaluation criteria (3 stages), and the results are shown in Table 1 and Table 2.

Evaluation Criteria:
A: maximum flame length of less than 15 cm
B: maximum flame length of 15 cm or more and intensive jetting
C: explosion

(3) Evaluation of Sulfur Dioxide Generation Amount

In each example, a theoretical amount of sulfur dioxide (SO₂) to be generated was determined by calculation. The evaluation was performed using the following criteria (3 stages), and the results are shown in Table 1 and Table 2.

Evaluation criteria: the theoretical SO₂ generation amount (mol/kg-produced Sb₂S₃) is
A: less than 3.5,
B: 3.5 or more and less than 7.0, or
C: 7.0 or more.

### 2.3. Evaluation Result

As apparent from Table 1 and Table 2, it was found that, in every Example in which antimony trisulfide was obtained through the mixing step of mixing the metal antimony powder, the antimony trioxide powder, and the sulfur powder to provide a mixture, and the heating step of heating the mixture, the generation of sulfur dioxide was suppressed, the produced antimony trisulfide had satisfactory purity, and the antimony trisulfide was able to be stably produced. In contrast, it was found that, in the product of each Comparative Example lacking any one of the metal antimony powder, the antimony trioxide powder, and the sulfur powder as a raw material, at least one of the suppression of generation of sulfur dioxide, the quality, or the safety was insufficient.

The present invention is not limited to the embodiments described above, and various modifications may be further made thereto. For example, the present invention encompasses substantially the same configurations as the configurations described in the embodiments (e.g., configurations having the same functions, methods, and results, or configurations having the same objects and effects). The present invention also encompasses configurations obtained by replacing non-essential parts of the configurations described in the embodiments with other configurations. The present invention also encompasses configurations exhibiting the same actions and effects, or configurations capable of achieving the same objects, as those of the configurations described in the embodiments. The present invention also encompasses configurations obtained by adding known technologies to the configurations described in the embodiments.

What is claimed is:

1. A method of producing antimony trisulfide, comprising:
mixing metal antimony powder, antimony trioxide powder, and sulfur powder to provide a mixture; and
heating the mixture.

2. The method of producing antimony trisulfide according to claim 1, wherein the mixture has a ratio (M_{O}:M_{M}) between an Sb mass (M_{O}) in the antimony trioxide powder and an Sb mass (M_{M}) in the metal antimony powder that falls within a range of from 1:2 to 2:1.

3. The method of producing antimony trisulfide according to claim 1, wherein the heating involves a maximum attainable temperature of 300° C. or more and 800° C. or less.

4. The method of producing antimony trisulfide according to claim 1, wherein the metal antimony powder has an average particle diameter of 120 μm or less.

5. The method of producing antimony trisulfide according to claim 1, wherein the antimony trioxide powder has an average particle diameter of 8 μm or less.

6. The method of producing antimony trisulfide according to claim 1, wherein the mixture has a total mass of 1 kg or more.
